(19) United States
(12) Patent Application Publication
(10) Pub. No.: US 2018/0089351 A1
(43) Pub. Date: Mar. 29, 2018

(54) METHOD TO INCREASE PERFORMANCE WHEN MODELING RANDOM LATCH VALUES

(71) Applicant: International Business Machines Corporation, Armonk, NY (US)

(72) Inventors: Tarang Agarwal, Uttar Pradesh (IN); Anupa E. Alex, Kerala (IN); Franziska Geisert, Altdorf (DE); Alexander Jung, Leinfelden-Echterdingen (DE); Karin Rebmann, Holzgerlingen (DE); Daniel D. Sentler, Steinenbronn (DE)

(21) Appl. No.: 15/276,980

(22) Filed: Sep. 27, 2016

(51) Int. Cl. G06F 17/50

(52) U.S. Cl. CPC G06F 17/5022

(57) ABSTRACT

A method and system for increasing performance when modeling random latch values are provided. The system including a power management logic that provides a power signal (VDD) that includes a high portion and a low portion, a transformation logic that receives the VDD from the power management logic, generates a updated signal (VDD2) based on the VDD, and outputs the updated signal (VDD2), wherein the VDD2 includes a low portion that extends one cycle, and a latch connected to transformation logic, wherein the latch receives VDD2.

### BACKGROUND

The subject matter disclosed herein generally relates to modeling random latch values during simulation testing and, more particularly, to increasing performance when modeling random latch values.

Increasing power consumption in semiconductor chips has led to entire portions of the chips being turned off to save power, when the system does not require the use of these portions of the chip. The portions that can be turned on and off while other portions of the chip remain on and operational can be referred to as power islands. These portions, or power islands, that are turned off can include one or more latches that can hold signals that correspond to data.

However, when a power island is turned off, an adjacent “on” portion of the chip may receive an unintended logic input from the power island. This can occur for a number of reasons, such as, for example a latch that outputs an unwanted output when a power signal to that latch is in a low state thereby placing the latch in an “off” state. While logical simulation may be used to test for the problem using multi-state logic, power management logic can take multiple cycles to switch between and on and off state and as a consequence slows down simulation significantly.

Accordingly, there is a desire to provide simulation improvements to improve the time such simulations take to run thereby improving the performance of the simulation modeling of the portions being tested.

### BRIEF DESCRIPTION

According to one embodiment a system for increasing performance when modeling random latch values is provided. The system including a power management logic that provides a power signal (VDD) that includes a high portion and a low portion, a transformation logic that receives the VDD from the power management logic, generates a updated signal (VDD2) based on the VDD, and outputs the updated signal (VDD2), wherein the VDD2 includes a low portion that extends one cycle, and a latch connected to transformation logic, wherein the latch receives VDD2.

In addition to one or more of the features described above, or as an alternative, further embodiments may include wherein the latch is further connected to a random generation logic, wherein the random generation logic generates a random value for the one cycle that VDD2 is low, and wherein the random value (D) is stored by the latch.

In addition to one or more of the features described above, or as an alternative, further embodiments may include a plurality of latches connected to the transformation logic, and a plurality of random generation logic, wherein each of the plurality of random generation logic is connected to one of the plurality of latches.

In addition to one or more of the features described above, or as an alternative, further embodiments may include wherein the low portion of the power signal (VDD) extends for a plurality of cycles.

In addition to one or more of the features described above, or as an alternative, further embodiments may include wherein the VDD2 that includes the low portion extends for one cycle corresponds to a first down cycle in the low portion of the VDD.

In addition to one or more of the features described above, or as an alternative, further embodiments may include wherein the latch is one selected from a group consisting of a simple set-reset latch, a gated latch with conditional transparency, a D flip-flop, a T flip-flop, and a JK flip-flop.

In addition to one or more of the features described above, or as an alternative, further embodiments may include wherein the simple set-reset latch is one selected from a group consisting of a SR NOR latch, a SR NAND latch, a SR AND-OR latch, and a JK latch.

In addition to one or more of the features described above, or as an alternative, further embodiments may include wherein the gated latch with conditional transparency is one selected from a group consisting of a gated SR latch, a gated D latch, and an Earle latch.

In addition to one or more of the features described above, or as an alternative, further embodiments may include wherein the D flip-flop is selected from a group consisting of a classical positive-edge-triggered D flip-flop, a master-slave edge-triggered D flip-flop, and an Edge-triggered dynamic D storage element.

In addition to one or more of the features described above, or as an alternative, further embodiments may include wherein the transformation logic provided the VDD2 to the plurality of latches and the plurality of random generation logic.

In addition to one or more of the features described above, or as an alternative, further embodiments may include wherein the random generation logic generates a pseudo random value for each cycle that an input signal is low.

According to one embodiment a computer implemented method for increasing performance when modeling random latch values is provided. The method including providing, using a power management logic, a power signal (VDD) that includes a high portion and a low portion, wherein the low portion extends for a plurality of cycles, receiving, at a transformation logic, the VDD from the power management logic, generating a updated signal (VDD2) based on the VDD, outputting the updated signal (VDD2), wherein the VDD2 includes a low portion that extends one cycle that corresponds to a first down cycle in the low portion of the VDD, and receiving the VDD2 at a latch connected to the transformation logic.

In addition to one or more of the features described above, or as an alternative, further embodiments may include generating, using a random generation logic, a random value for the one cycle that VDD2 is low, and storing, using the latch connected to the random generation logic, the random value.

In addition to one or more of the features described above, or as an alternative, further embodiments may include wherein the low portion of the power signal (VDD) extends for a plurality of cycles.

In addition to one or more of the features described above, or as an alternative, further embodiments may include wherein the VDD2 that includes the low portion extends for one cycle corresponds to a first down cycle in the low portion of the VDD.

According to one embodiment a computer implemented method of setting up a system for increasing performance when modeling random latch values is provided. The method including searching for and identifying one or more power pins, performing structural analysis of a wire based on the identified power pin connected to the wire, identifying power management (PM) logic connected to the wire, and inserting transformation logic along with the identified power management logic.

In addition to one or more of the features described above, or as an alternative, further embodiments may include receiving, at the transformation logic, an output from the PM logic, and

generating an updated output with a one cycle low portion that corresponds to the start of a low portion of the output from the PM logic.

In addition to one or more of the features described above, or as an alternative, further embodiments may include identifying any power pins that have not been identified and repeating the searching, performing, identifying, and inserting.

In addition to one or more of the features described above, or as an alternative, further embodiments may include determining all power pins have been identified.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The foregoing and other features, and advantages of the present disclosure are apparent from the following detailed description taken in conjunction with the accompanying drawings in which:

FIG. 1 is a block diagram illustrating one example of a processing system for practice of the teachings herein;

FIG. 2A is a block diagram of a power management verification system;

FIG. 2B is a depiction of signals that are provided by the power management verification system of FIG. 2A;

FIG. 2C is a graphical representation of a power signal of a power management verification system when VDD_IN turns to zero;

FIG. 3A is a block diagram of a power management verification system for increasing performance when modeling random latch values in accordance with one or more embodiments of the present disclosure;

FIG. 3B is a depiction of signals that are provided by a power management verification system for increasing performance when modeling random latch values in accordance with one or more embodiments of the present disclosure;

FIG. 3C is a graphical representation of a VDD_IN power signal and a VDD_IN_2 power signal of a power management verification system for increasing performance when modeling random latch values when VDD_IN turns to zero in accordance with one or more embodiments of the present disclosure;

FIG. 4 is a power management verification system for increasing performance when modeling random latch values that includes an integrated random generation logic within a latch in accordance with one or more embodiments of the present disclosure;

FIG. 5 is a power management verification system for increasing performance when modeling random latch values that includes a random generation logic that is separate and connected in series to a latch in accordance with one or more embodiments of the present disclosure;

FIG. 6 is a power management verification system for increasing performance when modeling random latch values that include a random generation logic that is connected in parallel and directly to a latch in accordance with one or more embodiments of the present disclosure;

FIG. 7 is a power management verification system for increasing performance when modeling random latch values that includes a plurality of random generation logic and latches in accordance with one or more embodiments of the present disclosure;

FIG. 8 is a power management verification system for increasing performance when modeling random latch values that includes a plurality of groups that each include a number of latches and random generation logic in accordance with one or more embodiments of the present disclosure;

FIG. 9 is a flowchart of a method for increasing performance when modeling random latch values in accordance with one or more embodiments of the present disclosure; and

FIG. 10 is a flowchart of a method of setting up a system for increasing performance when modeling random latch values in accordance with one or more embodiments of the present disclosure.

### DETAILED DESCRIPTION

As shown and described herein, various features of the disclosure will be presented. Various embodiments may have the same or similar features and thus the same or similar features may be labeled with the same reference numeral, but preceded by a different first number indicating the figure to which the feature is shown. Thus, for example, element “a” that is shown in FIG. X may be labeled “Xa” and a similar feature in FIG. Z may be labeled “Za.” Although similar reference numbers may be used in a generic sense, various embodiments will be described and various features may include changes, alterations, modifications, etc. as will be appreciated by those of skill in the art, whether explicitly described or otherwise would be appreciated by those of skill in the art.

Embodiments described herein are directed to a system and a method for increasing performance when modeling random latch values. For example, the method includes providing, using power management logic, a power signal (VDD) that comprises a high portion and a low portion, wherein the low portion extends for a plurality of cycles. The method also includes receiving, at transformation logic, the VDD from the power management logic. Further, the method includes generating a updated signal (VDD2) based on the VDD and outputting the updated signal (VDD2), wherein the VDD2 includes a low portion that extends one cycle that corresponds to a first down cycle in the low portion of the VDD. Finally, the method includes generating, using random generation logic, a random value for the one cycle that VDD2 is low and storing, using a latch connected to the random generation logic, the random value.

Additionally, embodiments described herein are directed to a system and a computer implemented method of setting up a system for increasing performance when modeling random latch values, the method including searching for and identifying one or more power pins. The method also includes performing structural analysis of a wire based on the identified power pin connected to the wire and identifying power management (PM) logic connected to the wire. The method also includes inserting transformation logic along with the identified power management logic.

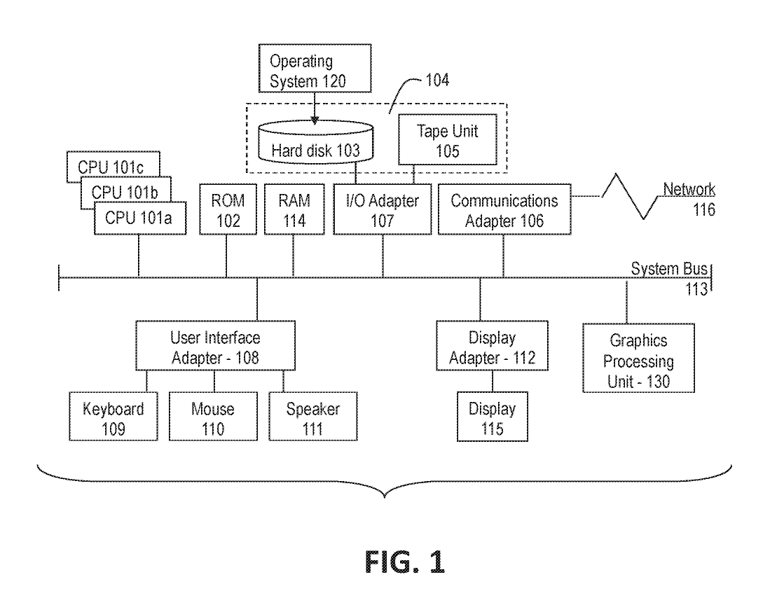

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

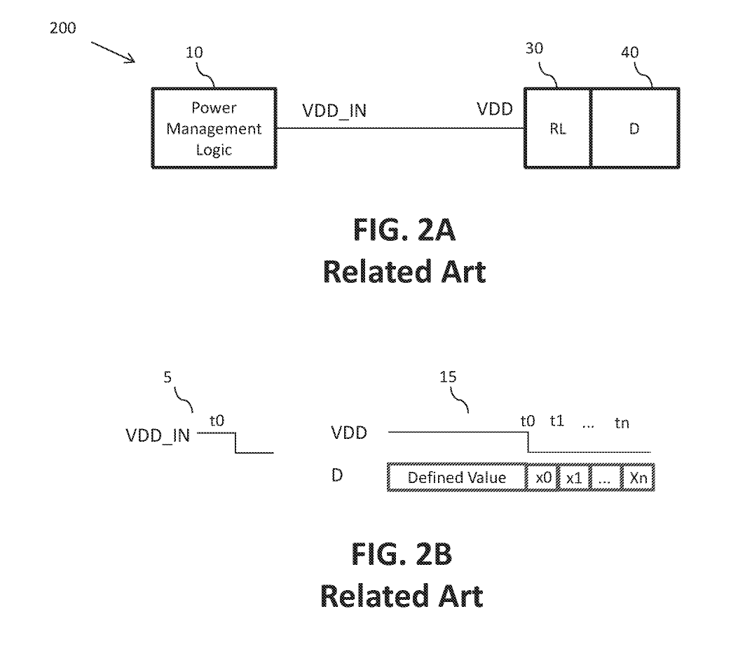

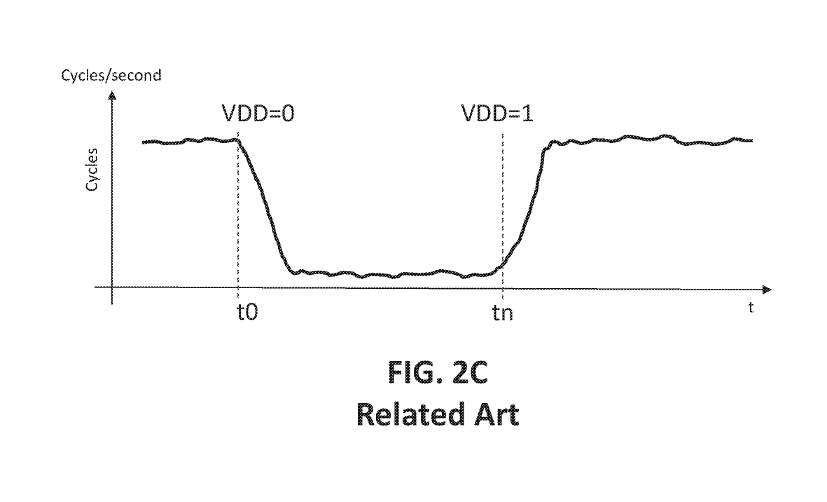

FIG. 2A is a block diagram of a power management verification system 200. A power management verification system 200 includes a power management logic block 10 that is connected to a latch 40 and a random generation logic block 30. As shown, the power management logic block 10 outputs a power signal (VDD_IN) along a wire toward the latch 40 and random generation logic block 30. The latch 40 and random generation logic block 30 receive the power signal along with any noise and power signal dissipation caused why traveling along the wire in the form of the power signal (VDD) as shown. According to one or more examples, the VDD_IN and the VDD signals may be substantially identical or may vary depending on the length of the wire and environmental conditions and surrounding architecture.

FIG. 2B is a depiction of signals that are provided by the power management verification system 200 of FIG. 2A. As shown, the power signal 5 VDD_IN may provide a power signal at time t0 as shown by a high section that can also be called a high state of the signal. The signal 5 then transitions to a low state, or low section, where the power signal no longer provide power. Further, FIG. 2B shows the power signal received at the latch 40 and random generation logic block 30. As shown signal VDD 15 provides power until time t0 and then transitions to a low state, or low section, and continues to stay in this low state for time t1 through tn as shown. During this low state the random generation logic block 30 will generate values to be stored in the latch 40. Specifically, the random generation logic block 30 generates values x0, x1, through xn during the low section of the VDD single correspond to times t0, t1, and tn as shown.

FIG. 2C is a graphical representation of a VDD power signal of the power management verification system 200 of FIG. 2A. As shown the VDD power signal provided by the power management logic block transitions at time t0 into a low section, or low state, during which power is not provided. The power management logic block remains in this state until tie tn when it can transition back into a high state, or high section for the VDD power signal thereby providing power again. During this time there is provided a constant latch randomization as the random generation logic block 30 continues to generate different values during each cycle within t0 to tn time block.

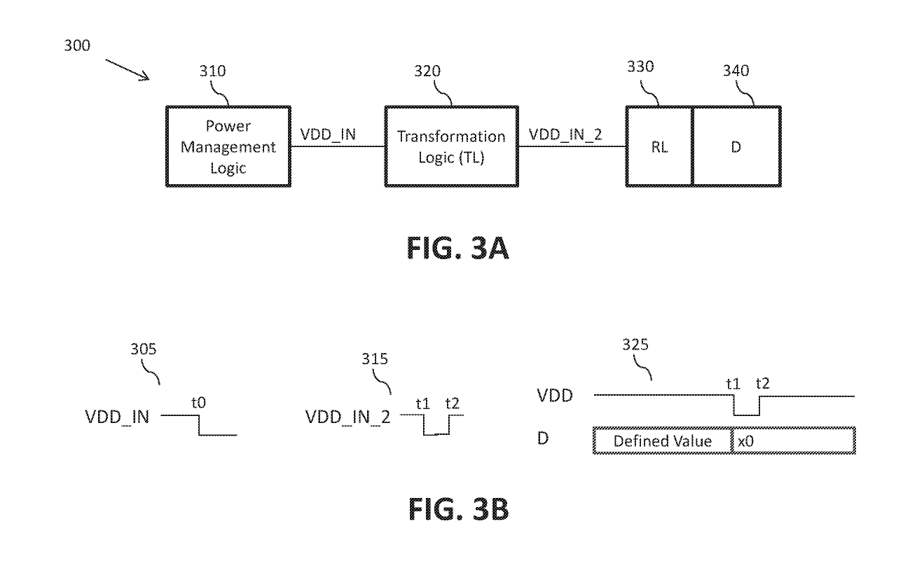

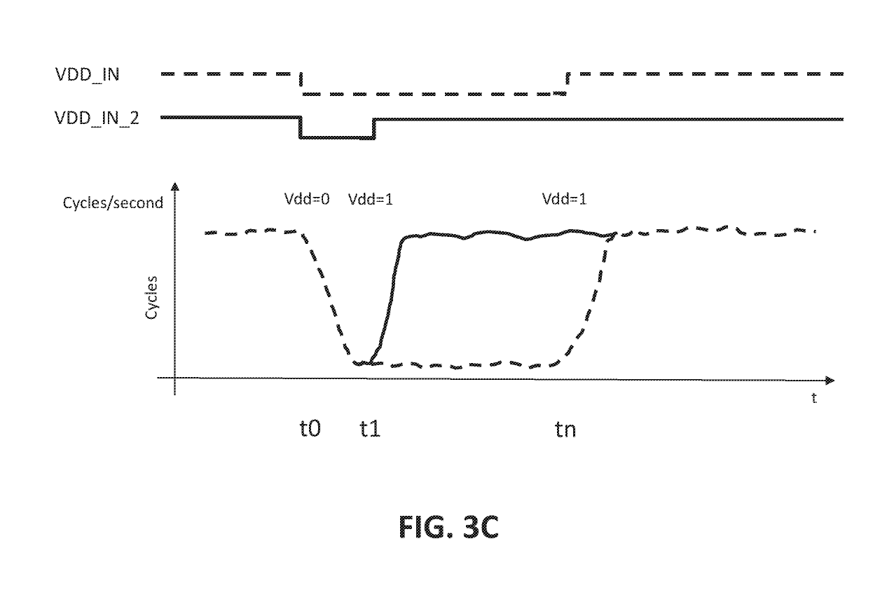

FIG. 3A is a power management verification system 300 for increasing performance when modeling random latch values in accordance with one or more embodiments of the present disclosure. As shown the power management verification system 300 includes a power management logic block 310, a transformation logic block 320, a latch 340 and random generation logic block 330. The power management logic block 310 is connected to the transformation logic block 320 and outputs a power signal (VDD_IN). The transformation logic block 320 receives the power signal provided by the power management logic block 310 and generates and outputs an adjusted output signal (VDD_IN_2) based on the received VDD_IN. The transformation logic 320 is connected to the random generation logic 330 and the latch 340. Accordingly, the transformation logic 320 provides VDD_IN_2 to the random generation logic 330 and latch 340.

According to one or more embodiments, the latch 340 can be a simple set-reset latch, a gated latch with conditional transparency, a D (“data” or “delay”) flip-flop, a T (“toggle”) flip-flop, a JK flip-flop, a combination of such latches, or some other type of latch. Further, according to one or more embodiments, if the latch is the simple set-reset latch, the latch can be a SR (“set-reset”) NOR latch, a SR NAND latch, a SR AND-OR latch, or a JK latch. Further, according to one or more embodiments, if the latch is the gated latch with conditional transparency, the latch can be a gated SR latch, a gated D latch, or a Earle latch. Additionally, according to one or more embodiments, if the latch is the D flip-flop, the latch can be a classical positive-edge-triggered D flip-flop, a master-slave edge-triggered D flip-flop, or an edge-triggered dynamic D storage element.

FIG. 3B is a depiction of signals that are provided by a power management verification system 300 for increasing performance when modeling random latch values in accordance with one or more embodiments of the present disclosure. Specifically, the VDD_IN signal 305 is shown which starts in a power providing high state that can also be called a high section. The VDD_IN signal 305 then transition at time t0 into a low state were power is no longer being provided, which can also be called a low section of the signal VDD_IN 305. The signal VDD_IN 305 remains in this low section state for multiple cycles as shown.

Also shown in signal VDD_IN_2 315 that is generated by the transformation logic 320 based on VDD_IN 305 and is out from the transformation logic 320 to the latch 340 and random generation logic 330. The VDD_IN_2 signal 315 is generated such that it also beginning in a power providing high state. The VDD_IN_2 signal 315 then transitions into a low section that does not provide power at time t1 then returns to a high state at time t2. The amount of time between t1 and t2 is equal to one clock cycle of the system. Accordingly the random generation logic 330 is only able to generate one random value during the low state. Specifically as shown, when signal VDD is received at the random generation logic 330 it is the VDD_IN_2 signal along with any noise or signal dissipation included. The VDD signal 325 includes the one cycle transition into and out of the low state as shown. During this low state portion the random generation logic 330 generates a single value x0 that is stored in the latch. Accordingly, the overall system is able to respond within one clock cycle with a random value generated and stored in the latch for testing.

Specifically, FIG. 3C is a graphical representation of a VDD_IN power signal and a VDD_IN_2 power signal of a power management verification system for increasing performance when modeling random latch values in accordance with one or more embodiments of the present disclosure. As shown, FIG. 3C shows a similar graphical representation of VDD as shown in FIG. 2C.

FIG. 3C goes on to additionally show VDD_IN_2 that is generated based on the VDD_IN signal and provided to the latch and random generation logic. As shown, the VDD_IN_2 signal cycles from a high section, or high state, for one clock cycle extending from time t0 to t1. This is shown superimposed against the VDD_IN which transitions from a high state to a low state at time t0 as well but remaining in a low state for multiple cycles until time to as shown before returning to a high state. Accordingly, it can be appreciated that providing the transformation logic allows for the system to respond to testing requests within one cycle rather than multiple cycles as shown.

In accordance with one or more embodiments, a system for increasing performance when modeling random latch values can have multiple different arrangements and still provide the above single cycle feature.

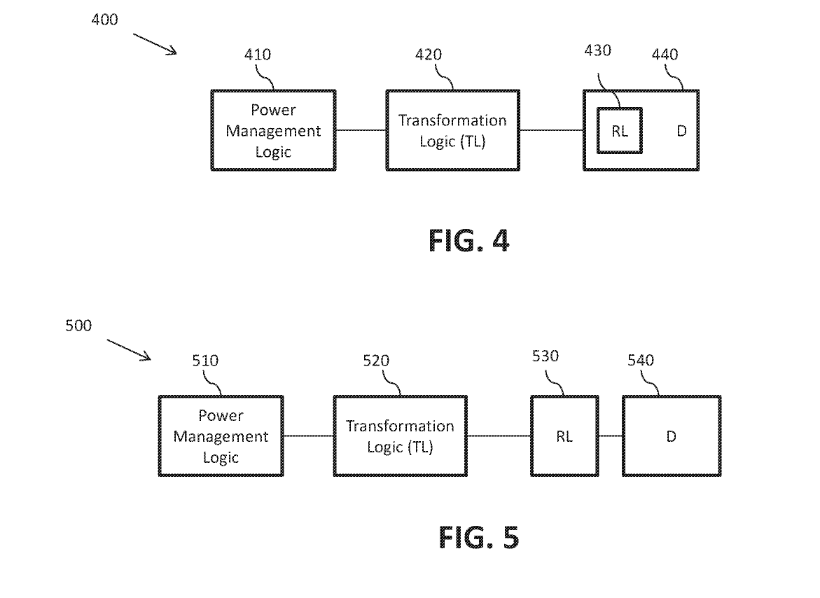

For example, FIG. 4 is a power management verification system 400 for increasing performance when modeling random latch values that includes an integrated random generation logic 430 within a latch 440 in accordance with one or more embodiments of the present disclosure. The system 400 includes a power management logic 410 that is connected to transportation logic 420. The transportation logic 420 is connected to the latch 440. The latch 440 includes an integrated random generation logic 430 that provides the random value during down cycle times in a received power signal from the transformation logic 420 is a similar fashion as described with reference to FIGS. 3A through 3C.

According to one or more embodiments, the latch 440 can be a simple set-reset latch, a gated latch with conditional transparency, a D flip-flop, a T flip-flop, a JK flip-flop, a combination of such latches, or some other type of latch. Further, according to one or more embodiments, if the latch is the simple set-reset latch, the latch can be a SR NOR latch, a SR NAND latch, a SR AND-OR latch, or a JK latch. Further, according to one or more embodiments, if the latch is the gated latch with conditional transparency, the latch can be a gated SR latch, a gated D latch, or a Earle latch. Additionally, according to one or more embodiments, if the latch is the D flip-flop, the latch can be a classical positive-edge-triggered D flip-flop, a master-slave edge-triggered D flip-flop, or an edge-triggered dynamic D storage element.

In accordance with one or more embodiments of the present disclosure, FIG. 5 is a power management verification system 500 for increasing performance when modeling random latch values that includes a random generation logic 530 that is separate and connected in series to a latch 540. In this embodiment, the system 500 includes a power management logic 510 that is connected to transformation logic 520. The transformation logic is connected to the random generation logic 530 which is in turn connected in series to the latch 540. Accordingly, in this embodiment, the random generation logic 530 will receive the power signal with a one cycle low section from the transformation logic 520 during which the random generation logic 530 will generate one random value that is then provided to the latch 540 which stores the value.

According to one or more embodiments, the latch 540 can be a simple set-reset latch, a gated latch with conditional transparency, a D flip-flop, a T flip-flop, a JK flip-flop, a combination of such latches, or some other type of latch. Further, according to one or more embodiments, if the latch is the simple set-reset latch, the latch can be a SR NOR latch, a SR NAND latch, a SR AND-OR latch, or a JK latch. Further, according to one or more embodiments, if the latch is the gated latch with conditional transparency, the latch can be a Gated SR latch, a Gated D latch, or a Earle latch. Additionally, according to one or more embodiments, if the latch is the D flip-flop, the latch can be a Classical positive-edge-triggered D flip-flop, a Master-slave edge-triggered D flip-flop, or an Edge-triggered dynamic D storage element.

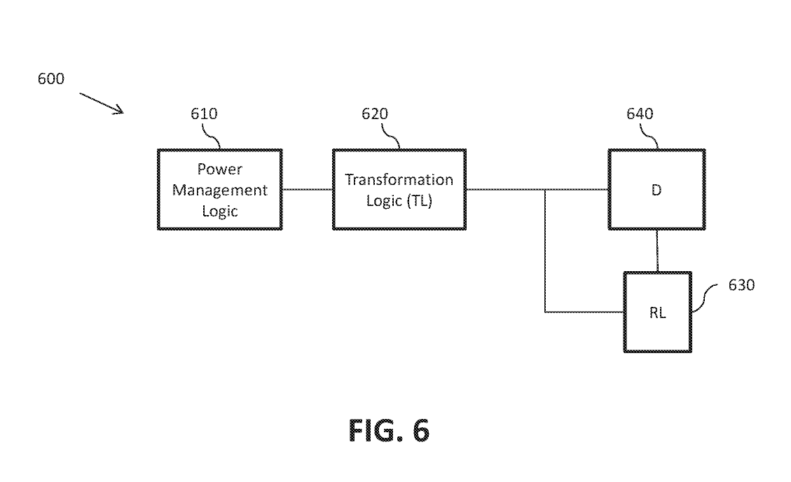

According to another embodiment, FIG. 6 is a power management verification system 600 for increasing performance when modeling random latch values that include a random generation logic 630 that is connected in parallel and directly to a latch 640. The system 600 includes a power management logic 610 and is connected to a transformation logic 620 which connects to the other elements, particularly the latch 640 and random generation logic 630. Specifically, in this embodiment, the random generation logic 630 and the latch 640 both receive the power signal with a one cycle low section from the transformation logic 620. The random generation logic 630 then generates a value that it transmits to the latch 640 which stores that received value from the random generation logic 630.

According to one or more embodiments, the latch 640 can be a simple set-reset latch, a gated latch with conditional transparency, a D flip-flop, a T flip-flop, a JK flip-flop, a combination of such latches, or some other type of latch. Further, according to one or more embodiments, if the latch is the simple set-reset latch, the latch can be a SR NOR latch, a SR NAND latch, a SR AND-OR latch, or a JK latch. Further, according to one or more embodiments, if the latch is the gated latch with conditional transparency, the latch can be a gated SR latch, a gated D latch, or a Earle latch. Additionally, according to one or more embodiments, if the latch is the D flip-flop, the latch can be a classical positive-edge-triggered D flip-flop, a master-slave edge-triggered D flip-flop, or an edge-triggered dynamic D storage element.

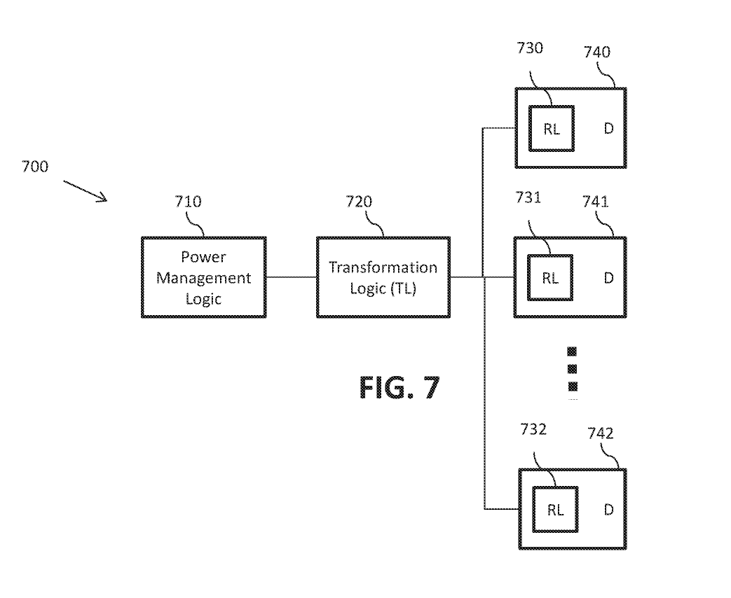

FIG. 7 is a power management verification system 700 for increasing performance when modeling random latch values that includes a plurality of random generation logic and latches in accordance with one or more embodiments of the present disclosure. Specifically, the system 700 includes a power management logic 710 that is connected to a transformation logic 720 that receives a power signal from the power management logic 710 and generates a new power signal that is provides to the other elements of the system 700. Particularly, the system 700 further includes a plurality of latches 740,741, and 742 that are each connected to the transformation logic 720. Further, the system 700 includes a plurality of random generation logic 730, 731, and 732. As shown the random generation logic 730, 731, and 732 are shown as being integrated into the plurality of latches 740, 741, and 742. However, according to other embodiments, the plurality of random generation logic 730, 731, 732 could be each arranged in a similar manner to any one or a combination of FIGS. 3A, 5, and 6.

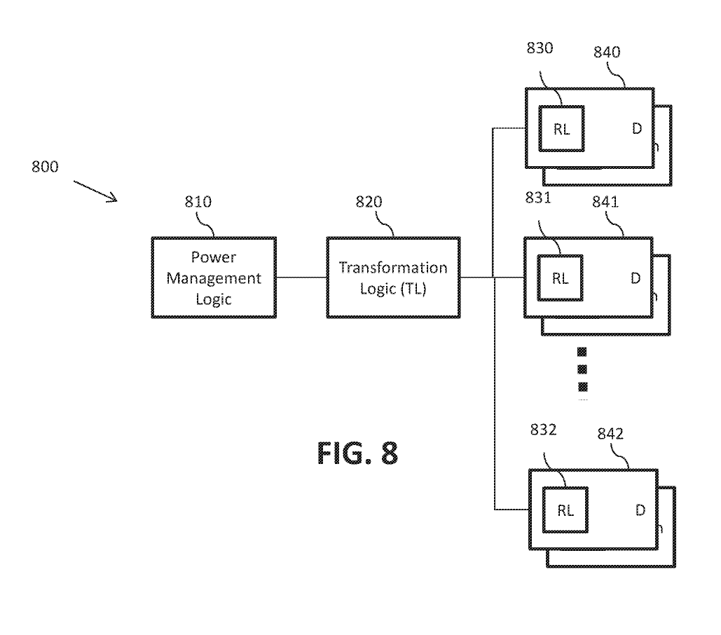

FIG. 8 is a power management verification system 800 for increasing performance when modeling random latch values that includes a plurality of groups that each include a number of latches 840, 841, 842 and random generation logic in accordance with one or more embodiments of the present disclosure. Specifically, as shown, the power management verification system 800 is substantially similar to FIG. 7 in that it includes a power management logic 810 connected to a transformation logic 820. Further, the transformation logic 820 is connected to a plurality of latches 840, 841, and 842 and a plurality of random generation logic 830, 831, and 832. Further, each pair of latch 840 and random generation logic 830 can include additional latch and random generation logic pairs stacked or adjacent to the first pair of latch 840 and random generation logic 830 as shown.

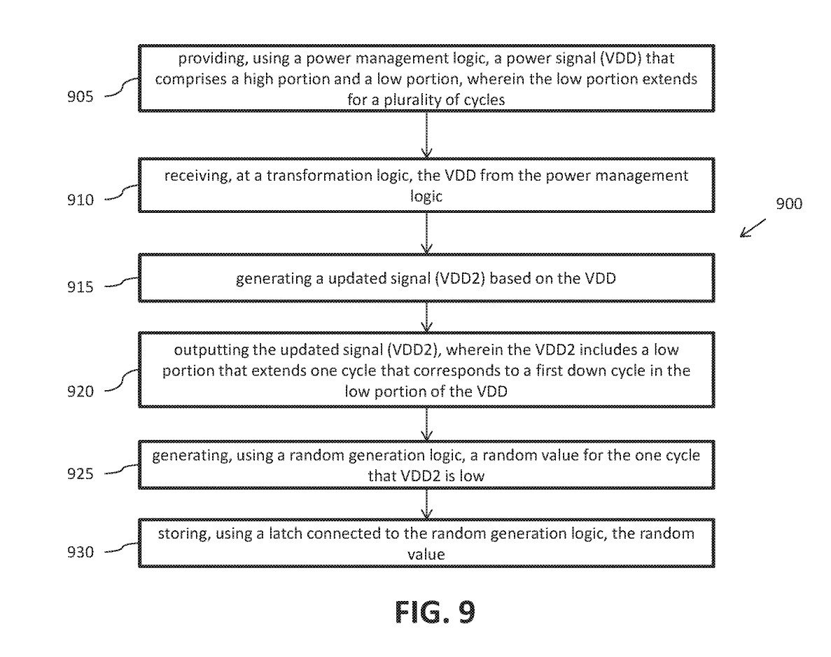

FIG. 9 is a flowchart of a method 900 for increasing performance when modeling random latch values in accordance with one or more embodiments of the present disclosure. The method 900 includes providing, using power management logic, a power signal (VDD) that comprises a high portion and a low portion, wherein the low portion extends for a plurality of cycles (operation 905). The method 900 includes receiving, at a transformation logic, the VDD from the power management logic (operation 910), generating a updated signal (VDD2) based on the VDD (operation 915) and outputting the updated signal (VDD2), wherein the VDD2 includes a low portion that extends one cycle that corresponds to a first down cycle in the low portion of the VDD (operation 920). Further, the method 900 includes generating, using a random generation logic, a random value for the one cycle that VDD2 is low (operation 925) and storing, using a latch connected to the random generation logic, the random value (operation 930).

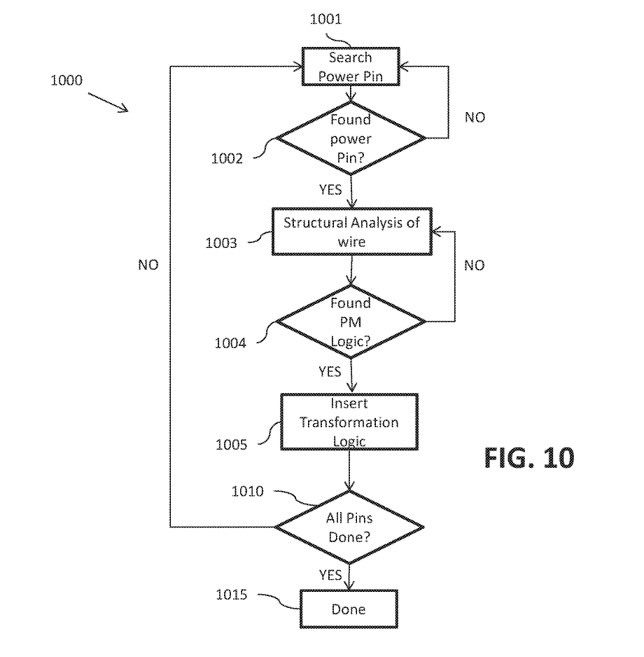

FIG. 10 is a flowchart of a method 1000 of setting up a system for increasing performance when modeling random latch values in accordance with one or more embodiments of the present disclosure. The method 1000 includes searching for and identifying one or more power pins (operations 1001 and 1002). The method 1000 also includes performing structural analysis of a wire based on the identified power pin connected to the wire (operation 1003). The method 1000 also includes identifying power management (PM) logic connected to the wire (operation 1004). Further, the method 1000 includes inserting transformation logic along with the identified power management logic (1005). Finally, according to one or more embodiments, the method 1000 can include identifying any power pins that have not been identified and repeating the searching, performing, identifying, and inserting and then once complete determining all power pins have been identified (operations 1010 and 1015).

Advantageously, embodiments described herein provide randomization for only one cycle, which can lead to performance enhancement of the system and method.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the embodiments in the form disclosed. Many modifications and variations will be apparent to those of ordinary skill in the art without departing from the scope of the disclosure. The embodiments were chosen and described in order to best explain the principles of the disclosure and the practical application, and to enable others of ordinary skill in the art to understand various embodiments with various modifications as are suited to the particular use contemplated.

The present embodiments may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, Smalltalk, C++, or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present invention are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Accordingly, the present disclosure is not to be seen as limited by the foregoing description, but is only limited by the scope of the appended claims.

What is claimed is:

1. A system for increasing performance when modeling random latch values, the system comprising:
a power management logic that provides a power signal (VDD) that comprises a high portion and a low portion,
a transformation logic that receives the VDD from the power management logic, generates a updated signal (VDD2) based on the VDD, and outputs the updated signal (VDD2), wherein the VDD2 includes a low portion that extends one cycle; and
a latch connected to transformation logic, wherein the latch receives VDD2.

2. The system of claim 1, further comprising:
wherein the latch is further connected to a random generation logic,
wherein the random generation logic generates a random value for the one cycle that VDD2 is low, and
wherein the random value (D) is stored by the latch.

3. The system of claim 1, further comprising:
a plurality of latches connected to the transformation logic; and
a plurality of random generation logic, wherein each of the plurality of random generation logic is connected to one of the plurality of latches.

4. The system of claim 1,
wherein the low portion of the power signal (VDD) extends for a plurality of cycles.

5. The system of claim 4, wherein the VDD2 that includes the low portion extends for one cycle corresponds to a first down cycle in the low portion of the VDD.

6. The system of claim 1,
wherein the latch is one selected from a group consisting of a simple set-reset latch, a gated latch with conditional transparency, a D flip-flop, a T flip-flop, and a JK flip-flop.

7. The system of claim 6,
wherein the simple set-reset latch is one selected from a group consisting of a SR NOR latch, a SR NAND latch, a SR AND-OR latch, and a JK latch.

8. The system of claim 6,
wherein the gated latch with conditional transparency is one selected from a group consisting of a gated SR latch, a gated D latch, and an Earle latch.

9. The system of claim 6,
wherein the D flip-flop is selected from a group consisting of a classical positive-edge-triggered D flip-flop, a master-slave edge-triggered D flip-flop, and an Edge-triggered dynamic D storage element.

10. The system of claim 3,
wherein the transformation logic provided the VDD2 to the plurality of latches and the plurality of random generation logic.

11. The system of claim 1,
wherein the random generation logic generates a pseudo random value for each cycle that an input signal is low.

12. A computer implemented method for increasing performance when modeling random latch values, the method comprising:
providing, using a power management logic, a power signal (VDD) that comprises a high portion and a low portion, wherein the low portion extends for a plurality of cycles;
receiving, at a transformation logic, the VDD from the power management logic,
generating a updated signal (VDD2) based on the VDD;
outputting the updated signal (VDD2), wherein the VDD2 includes a low portion that extends one cycle that corresponds to a first down cycle in the low portion of the VDD; and
receiving the VDD2 at a latch connected to the transformation logic.

13. The computer implemented method of claim 12,
generating, using a random generation logic, a random value for the one cycle that VDD2 is low; and
storing, using the latch connected to the random generation logic, the random value.

14. The computer implemented method of claim 12, wherein the low portion of the power signal (VDD) extends for a plurality of cycles.

15. The computer implemented method of claim 14, wherein the VDD2 that includes the low portion extends for one cycle corresponds to a first down cycle in the low portion of the VDD.

16. A computer implemented method of setting up a system for increasing performance when modeling random latch values, the method comprising:
searching for and identifying one or more power pins;
performing structural analysis of a wire based on the identified power pin connected to the wire;
identifying power management (PM) logic connected to the wire; and
inserting transformation logic along with the identified power management logic.

17. The computer implemented method of claim 16, further comprising:
receiving, at the transformation logic, an output from the PM logic; and
generating an updated output with a one cycle low portion that corresponds to the start of a low portion of the output from the PM logic.

18. The computer implemented method of claim 16, further comprising:
identifying any power pins that have not been identified and repeating the searching, performing, identifying, and inserting.

19. The computer implemented method of claim 16, further comprising:
determining all power pins have been identified.
